(19) United States
(12) Patent Application Publication
(10) Pub. No.: US 2003/0175482 A1
(43) Pub. Date: Sep. 18, 2003

(54) Two-piece sealant

(76) Inventor: David Porter, Swindon (GB)

Correspondence Address: REINHART BOERNER VAN DEUREN S.C., ATTN: LINDA GABRIEL, DOCKET COORDINATOR, 1000 NORTH WATER STREET, SUITE 2100, MILWAUKEE, WI, 53202, US

(21) Appl. No.: 10/119,666

(22) Filed: Apr. 10, 2002

(30) Foreign Application Priority Data
Mar. 15, 2002 (GB) 0206187.7

(51) Int. Cl. B32B 3/00; E04B 1/682; F16J 15/02; F16J 15/08; F16J 15/10

(52) U.S. Cl. 428/172; 277/316; 277/644; 277/654

(57) ABSTRACT

A sealing system is disclosed which includes a preformed molded or extruded strip which may be used in conjunction with a fluid water-based polymeric sealant to cover or seal a joint or gap between two adjacent surfaces in a waterproof manner. The strip has a cross-sectional configuration which is generally trapezoidal, with two sides which will engage the two adjacent surfaces, a larger base which will be the only side of the strip visible upon installation, and a smaller base which will face the joint or gap between the two adjacent surfaces. The larger base may be either concave or convex to provide a pleasing appearance, the strip may be secured with a fluid water-based polymeric sealant.

### BACKGROUND OF THE INVENTION

### FIELD OF THE INVENTION

The present invention relates generally to sealants which may be used to cover or to seal a gap between two surfaces or may be used decoratively as a profile around a frame, and more particularly to waterproof sealants for use in bathrooms and kitchens and around windows.

Seals in bathrooms and kitchens and around windows are well known and come in many different forms. However, each has disadvantages, particularly when applied by non-experts (for example in do-it-yourself (“DIY”) applications). Tidy watertight seals can be hard to attain. A first method of sealing uses use a preformed sealing strip having one or more adhesive strips attached to the back which is subsequently covered by a paper backing tape to protect the adhesive. To apply the seal, these preformed strips are folded in half along a score line in the outer surface of the strip such that the adhesive faces the two surfaces adjacent the gap which is to be sealed. The backing paper is gradually removed and the strip is pushed firmly into the area to be sealed, which has been carefully pre-prepared (i.e. cleaned from previous seals, dirt, etc.). This continues along the desired length. For a corner joint, it is usually necessary to overlap the bottom half of the strip or, if the strip is cut at an angle to make a tidy joint, there is the problem of an additional joint between adjacent portions of the strip which may be susceptible to leaking.

Problems with this form of seal, in addition to the difficulties associated with obtaining a neat and waterproof seal in corners (a place where liquid may particularly accumulate), include the fact that the outer, waterproof surface does not actually form a close fitting seal with the surfaces to which it is attached. The adhesive strips are in direct contact with the surfaces and the sealing strip is in contact with the adhesive strips. The adhesive strips may provide some sealing action, but liquid can penetrate the adhesive over time, particularly along the grout lines between adjacent tiles. Due to the uneven surface in this region, a watertight seal is unlikely to be formed both on the two tiles and the grout between them. In addition, the relative cost of assembling the strip with a score line down the middle and one or more strips of adhesive on the rear, subsequently covered by backing paper, is high, as a number of steps are required in the production process.

A second form of sealant which is known and widely used is the application of a fluid sealant into the gap. The sealant may be manipulated for a few minutes after application before it “goes off” and sets in a relatively solid (cured) formation. The seal may therefore be applied to the gap between a bath and the wall, or tiles on the wall by any suitable means, e.g. a squeezable tube or using a sealant gun. In the period shortly after applying the sealant, it can be smoothed over using a wet knife or other suitable object to provide a neat finish. It may also be appropriate to put tape on the surfaces before applying the seal to try and give clean edges to the seal when the tape is removed. A continuous bead of sealant is required to obtain a watertight seal and the application of such a regular bead can be difficult. In any event, considerable care is required to obtain both a neat finish and a watertight seal.

A third form of seal is a silicone sealant kit for use around bathtubs and showers. It comprises a profiled silicone rubber strip. The strip is eleven feet long (to use around a standard bathtub) and is cut at suitable points using a patented miter block included in the pack. The strip is approximately thirteen to fifteen millimeters wide at the widest point, and is substantially hollow. A silicone adhesive is applied to the two surfaces around the gap to be sealed. The adhesive is applied simultaneously to both surfaces using a specially designed patented nozzle supplied with the kit. The strip (which has previously been cut to the required length and shape) is then carefully pushed into the two strips of silicone adhesive. Excess adhesive is squeezed out at the top and bottom of the strip and is left to dry. Once it has set, the excess silicone is cut away using a sharp knife. Care must be taken at this point to not damage the integrity of the seal and also to cut in a straight line (top and bottom) to provide a neat finish.

At corners, care has to be taken to match up the two strips exactly or the hollow nature of the strip may allow ingress of water at the joint, thereby weakening the seal. The application of this type of seal is difficult and very time consuming. It is also mainly suitable for places where there is a large gap to be sealed because of the size of the silicone strip and the associated nozzle attachment.

### SUMMARY OF THE INVENTION

The present invention seeks to overcome the various problems of the prior art by providing a sealing system which is inexpensive to produce, quick and easy to apply, and which provides a neat and waterproof finish.

According to the present invention, there is provided a sealing system comprising a preformed molded or extruded strip and a fluid water-based polymeric sealant. The invention also extends to a method of applying a seal to a gap or joint between two surfaces in which: a fluid water-based polymeric sealant is applied to the gap or joint; a preformed molded or extruded strip is laid into the sealant in the gap such that the sealant is forced both into the gap and outwardly and forms a tight seal with both of the surfaces; and excess sealant, still in its non-set fluid form, is wiped away from the edges of the strip. The invention also extends to a molded or extruded strip of material in the general shape of a trapezoid for use in a sealing system.

Using the sealing system and method of the present invention, a clean, quick, and easy to apply waterproof seal is formed in the gap or joint between the two surfaces.

The molded or extruded strip may be of any shape suitable for the gap to be filled or joint to be decorated, but is preferably in the shape of a trapezoid with the outwardly facing surface in use optionally being concave. The use of such a molded or extruded strip provides a discrete neat finish. Other shapes of strip can be used where appropriate, for example in providing an ornate finish around a doorframe or window frame. In this case, the outer surface of the molded or extruded strip may be a convex or wavy surface.

The sealant used is a water-based polymeric composition which has good sealant, aging and cohesive properties. It therefore preferably has a low filler concentration in comparison to the polymeric material. An example of a suitable sealant composition is UniBond All Purpose Sealant manufactured by Henkel AG. Such polymeric compositions are substantially waterproof when set and can be used in areas such as bathrooms or kitchens where the seal would be in regular contact with water. They may also be used in decorative applications, for example around door and window frames. Water-based polymeric sealants have the advantage over silicone based sealants in that they are easy to clean (on application) and can be painted to match surrounding surfaces. A polymeric water based sealant may be fully set and waterproof in a few hours, and ready for painting within a day.

On application, the excess sealant, which is forced out when the strip is applied, may be wiped away simply using a damp sponge or cloth. It is not necessary to wait for an adhesive to set and go off before cutting away the excess.

Similar water-based polymeric sealants may be used alone, as discussed above, but a neat finish is difficult to obtain. Using the sealant in combination with a preformed molded or extruded strip avoids these problems, as the external finish is largely determined by the preformed strip. The waterproof seal is formed by the dominance of the preformed strip in the gap with the sealant bonding the strip to both of the surfaces and also sealing the small gaps which may arise due to uneven surfaces, for example where there is grout between tiles. The sealant does not have to be applied in a single neat continuous bead as the molded or extruded strip provides the finish to the seal.

Preferably the molded or extruded strip is made of a polymeric material. Preferred materials include PVC, polyethylene, and other thermoplastic polymers that can provide a flexible extrusion capable of being bonded using a water-based polymeric sealant. Particularly preferred is a PVC strip, as this can be economically produced and is easy to keep clean. The molded or extruded strip can be made of any color or size to suit the location where it is to be put. A preferred color for the strip is white or an off-white color such as almond, bisque, or cream to match most bath suites or black to provide a contrast with the surrounding surfaces. A typical strip may be five, seven or nine millimeters wide, although any width may be produced provided that it is wide enough for the desired purpose - [symbol] sealing or decorative. A width in the range of three to twenty-five millimeters is preferred, with three to fifteen millimeters being more preferable, and four to twelve millimeters being most preferred.

The sealing system of the present invention can be painted or decorated if desired. The system is easily cleaned when compared to the prior art system comprising just a sealant. The extruded or molded strip can be cleaned simply by wiping down with a damp sponge or cloth or with bleach. The strip is a sealed surface which is non-porous. The molded or extruded strip can be easily pulled out of the gap which it has sealed or joint which it has covered as the strip has substance. Traditionally, old seals are difficult to remove, as the sealant does not have inherent structural strength since the seal and the sealant are designed to fill the holes and not to form a uniform strong piece. There is therefore a tendency for the old seal to break up into many pieces on removal, resulting in a time consuming preparation process before a new seal can be applied. The small amount of sealant remaining from the gap or joint where a seal according to the present invention had previously been used can be easily cleaned up so that a good surface is prepared for the introduction of a new seal.

### DESCRIPTION OF THE DRAWINGS

The present invention may be put into practice in a number of different ways and an embodiment will described here in further detail by way of example, with reference to the accompanying drawings in which:

FIG. 1 shows a sealing strip of the prior art;

FIG. 2 shows an example of a shape of the molded or extruded strip of the present invention;

FIG. 3 shows a molded or extruded strip according to the present invention being laid in the sealant in the gap between two largely perpendicular surfaces; and

FIG. 4 shows an alternative embodiment of the molded or extruded strip according to the present invention.

### DESCRIPTION OF THE PREFERRED EMBODIMENT

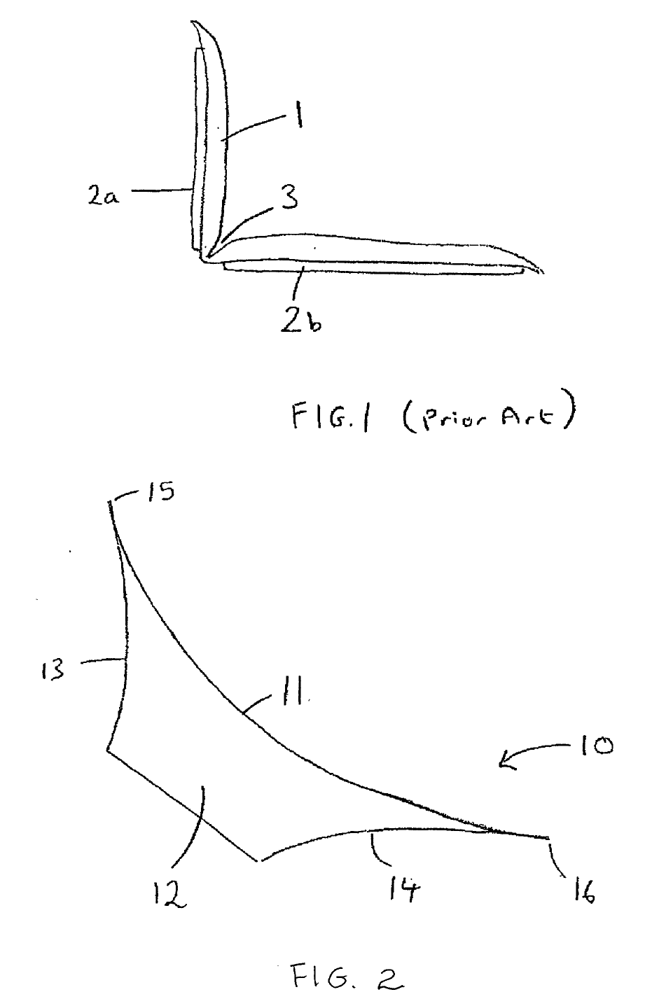

FIG. 1 shows a sealing strip according to a prior art process. The polymeric strip 1 has a score 3 longitudinally along its length generally dividing the strip into two roughly equal halves. The score 3 may be to a depth of fifty percent or greater of the whole thickness of the strip. On either side of the score on the rear of the strip, two strips of adhesive 2a, 2b are attached. These adhesive strips are then covered by a paper backing tape (not shown) to retain the adhesive qualities of the strip before it is used. To apply the strip to the wall, the surface is prepared (cleaned) and a small section of the backing paper is removed from the adhesive strips. The polymeric strip is then pushed down into the gap and the adhesive strips are firmly pushed against the two surfaces.

However, as indicated above, this method of sealing may be inefficient as the polymeric strip 1, does not actually form a direct seal with the surfaces but is attached by means of the strips of adhesive 2a, 2b. These adhesive strips may not exactly follow all the contours of the surfaces onto which the seal is made. In particular, the adhesive may not attach securely to the grout between adjacent tiles. There are therefore weak points or channels in the seal through which liquid can eventually seep. Liquid can also accumulate on the top of the adhesive strip 2a and gradually weaken the adhesion to the surface.

It is also difficult to obtain a good seal in corners (where liquid may accumulate and remain in a pool sitting on the seal) using this form of sealant. The strip has to be cut very accurately so that the pieces meet exactly leaving no gap for any liquid to pass through. Alternatively the bottom layer on the second side may be laid over that which is already attached. This may provide a better seal, but does not produce such a neat appearance to the seal.

The present invention comprises a molded or extruded strip such as that shown in FIG. 2 together with a fluid water-based polymeric sealant. The shape of the molded or extruded strip will be dictated by the use. The strip 10 shown in FIG. 2 is particularly suitable for use around baths, sinks, and worktops and around window frames. The outer concave surface 11 which is the larger base (the parallel sides of a trapezoid being referred to as bases) of the generally trapezoidal shape of the strip 10 provides a tidy discrete finish when the seal is applied. The protruding ridge 12 behind the outer surface 11 extends into the gap to be sealed allowing the two remaining sides 13, 14 of the trapezoidal shape of the strip 10 to rest on the two substantially perpendicular surfaces providing a number of direct points of contact between the molded or extruded strip and the surfaces. In particular, the vertices 15, 16 will be in direct contact with the surfaces being sealed. The two remaining sides 13, 14 may also have a concave surface configuration as illustrated, and the trapezoidal shape of the strip 10 may be an isosceles trapezoid in which the two sides are of equal length and the angles between them and the larger base of the trapezoidal shape are also identical.

The molded or extruded strip 10 is preferably made of PVC as it is inexpensive and easy to use and clean. In addition, if the strip 10 has a twist or kink in it following packaging it can be easily corrected by soaking the strip 10 in hot water for a few minutes. The strip 10 can then be used without problem.

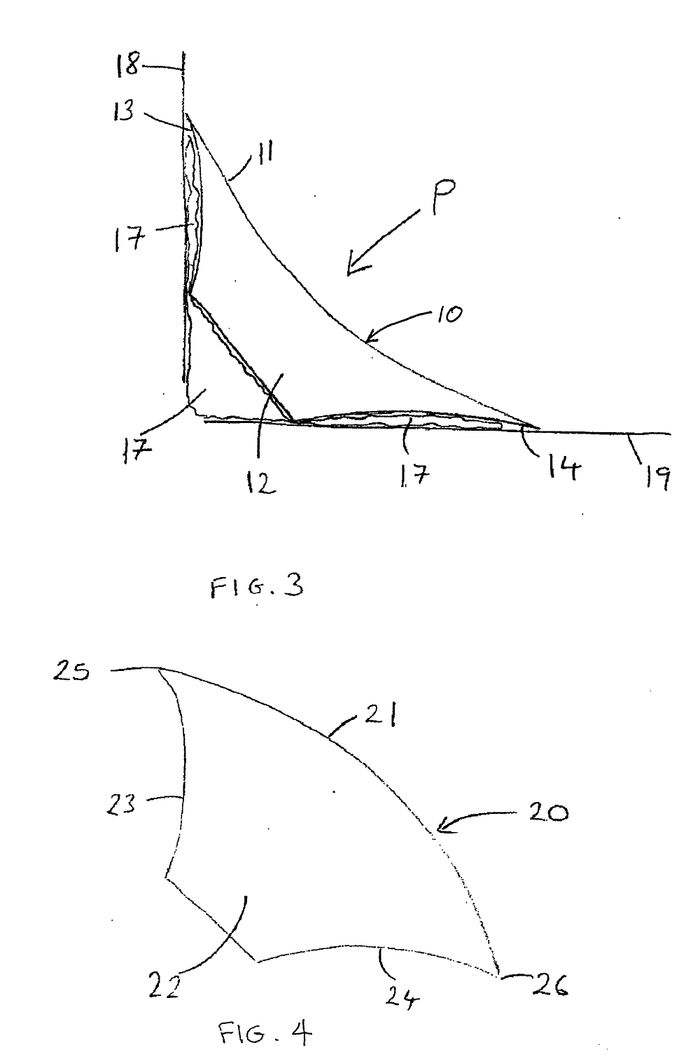

Referring now to FIG. 3, to apply the seal to a gap or a joint, the sealant 17 is applied to the gap or joint between two surfaces 18, 19 in a slight excess. The sealant is applied predominantly as a single continuous bead which neither has to be neat or accurate because the final appearance of the seal is dictated by the shape of the strip 10 and the excess sealant is wiped away. The molded or extruded strip 10 is laid on the sealant and pushed firmly into the sealant in the direction of arrow P in FIG. 2. The sealant 17 will be forced further into the gap and out at both the top and bottom of the strip 10. The sealant 17 is also forced into any slightly larger gaps between the strip 10 and the surfaces 18, 19 (for example where there is grout between adjacent tiles) and a watertight seal is formed along the complete length of the strip 10.

If the initial positioning of the strip 10 is not satisfactory, for example, if it does not extend right into a corner, the strip 10 can be lifted partly or completely and repositioned. Once the position of the strip 10 is satisfactory, excess sealant 17 can be removed while it is still fluid by simply wiping a damp sponge or cloth along the length of the joint or seal shortly after the molded strip 10 has been pushed into the gap or joint. A strong seal is therefore formed along the sides 13, 14 to the top and the bottom of the strip 10 and in the gap itself with the majority of the gap being sealed by the molded or extruded strip 10. The final appearance of the seal should be just the shape of the outer surface of the preformed molded or extruded strip 10.

A miter joint can be cut at a suitable angle by the user to fit the seal to the specific dimensions of the area in which they are working. Naturally, on application some sealant 17 will be forced into the joint between the two cut strips 10 bonding the strips 10 together and providing a waterproof seal in the corner. While a flush meeting of the two strips 10 at the corner is preferred, for example by two forty-five degree cuts meeting in a right-angled corner, a perfect meeting is not essential. If there is a slight gap between the two strips 10, this will be filled by the sealant and a waterproof seal will be formed. Thus the sealing system of the present invention can be installed quickly and safely providing an attractive finish and secure seal.

FIG. 4 shows an alternative shape for the preformed molded or extruded strip. This strip 20 has a convex outer surface 21 thereby providing a more prominent finish to the seal or decorative cover. As before, the protruding ridge 22 extends back into the gap or joint and sealant is applied in slight excess to the gap or joint and the strip 20 is pushed firmly into the sealant. The sealant then spreads out over the strip 20 and a strong bond forms along both surfaces 23, 24 (which may, if desired, be concave as illustrated). Again, the vertices 25, 26 are in direct contact with the surfaces to be sealed. Naturally, further decoration can be added to the outer visible surface of the molded or extruded strip 20 as appropriate.

The preformed molded or extruded strips 10 and 20 can be made in any color and any shape so that the seal blends in or stands out as appropriate. In particular the strips 10 and 20 may be black, for example where a contrast may be required with surrounding white tiles or white to blend in discretely with the tiles. Alternately, they may be an off-white color such as almond, bisque, or cream to match a bath suite.

After time, if a new seal is wanted, for example of a different color or because one of the surfaces is to be moved (for example a new bath or doorframe is installed) the old seal can be removed easily compared to silicone seals for the reasons discussed above.

While the invention has been exemplified using two substantially perpendicular surfaces, it will be appreciated that the invention would work equally well for two surfaces which are at an angle other than perpendicular to each other. Using appropriately shaped strips, a waterproof seal could be formed using the method of the present invention for surfaces at an angle between, for example, forty-five degrees and one hundred fifty degrees relative to each other.

The present invention provides a quick and easy method of forming an attractive waterproof seal in a range of locations from the traditional baths and showers to window and doorframes and worktops.

Although an exemplary embodiment of the strip seal of the present invention has been shown and described with reference to particular embodiments and applications thereof, it will be apparent to those having ordinary skill in the art that a number of changes, modifications, or alterations to the invention as described herein may be made, none of which depart from the spirit or scope of the present invention. All such changes, modifications, and alterations should therefore be seen as being within the scope of the present invention.

What is claimed is:

1. A sealing system comprising:
a preformed molded or extruded strip; and
a fluid water-based polymeric sealant.

2. A sealing system as defined in claim 1, in which the strip has a cross-sectional configuration which is generally trapezoidal.

3. A sealing system as defined in claim 2, in which the outwardly facing surface of the trapezoidal cross-sectional configuration of the strip in use is concave.

4. A sealing system as defined in claim 2, in which the outwardly facing surface of the trapezoidal cross-sectional configuration of the strip in use is convex.

5. A sealing system as defined in claim 1, in which the preformed strip is made of polymeric material.

6. A sealing system as defined in claim 5, in which the polymeric material is a thermoplastic polymer capable of providing a flexible extrusion and which can be bonded using a water-based polymeric sealant.

7. A sealing system as defined in claim 6, in which the polymeric material is PVC or polyethylene.

8. A sealing system as defined in claim 1, in which the preformed strip is white, black, or colored.

9. A sealing system as defined in claim 1, in which the preformed strip is between approximately three and twenty-five millimeters wide at its widest point.

10. A sealing system as defined in claim 9, in which the preformed strip is between approximately three and fifteen millimeters wide at its widest point.

11. A sealing system as defined in claim 10, in which the strip is between approximately four and twelve millimeters wide at its widest point.

12. A method of applying a seal to a gap or joint between two surfaces comprising:
applying a fluid water-based polymeric sealant to the gap or joint;
laying a preformed molded or extruded strip into the sealant in the gap or joint such that the sealant is forced both into the gap or joint and outwardly and forms a tight seal between the strip and both of the surfaces; and
wiping away excess sealant still in its non-set fluid form from the edges of the strip.

13. A molded or extruded strip of material having cross-sectional configuration generally resembling a trapezoid, for use in a sealing system.

14. A strip as defined in claim 13, in which the outwardly facing surface of the strip in use is concave.

15. A strip as defined in claim 13, in which the outwardly facing surface of the strip in use is convex.

16. A strip as defined in claim 13, in which the strip is made of a polymeric material.

17. A strip as defined in claim 16, in which the polymeric material is a thermoplastic polymer capable of providing a flexible extrusion and which can be bonded using a water-based polymeric sealant.

18. A strip as defined in claim 17, in which the polymeric material is PVC or polyethylene.

19. A strip as defined in claim 13, in which the strip is white, black or colored.

20. A strip as defined in claim 13, in which the strip is between three and twenty-five millimeters wide at its widest point.

21. A strip as defined in claim 20, in which the strip is between three and fifteen millimeters wide at its widest point.

22. A strip as defined in claim 21, in which the strip is between four and twelve millimeters wide at its widest point.

23. A sealing strip for use in conjunction with a sealant material to seal a gap or joint between two adjacent surfaces defining an angle therebetween, comprising
an extended strip having a cross-sectional configuration which generally resembles an isosceles trapezoid having a longer base, a shorter base, and two sides, wherein said sides are at an angle with respect to each other which is selected to be approximately the same as the angle between the two adjacent surfaces.

24. A sealing strip as defined in claim 23, wherein the longer base of said extended strip is concave.

25. A sealing strip as defined in claim 23, wherein the longer base of said extended strip is convex.

26. A sealing strip as defined in claim 23, wherein the angle between said sides of said strip is approximately ninety degrees.

27. A sealing strip as defined in claim 23, wherein said two sides of said extended strip are concave.

28. A sealing strip as defined in claim 23, additionally comprising:
a fluid water-based polymeric sealant which may be dispensed to the two surfaces, following which said extended strip is pressed into said dispensed sealant to form a tight seal between said extended strip and the two surfaces.
